(19) United States
(12) Patent Application Publication
(10) Pub. No.: US 2013/0133370 A1
(43) Pub. Date: May 30, 2013

(54) APPARATUS FOR REDUCING RADIATIVE HEAT LOSS FROM A FORMING BODY IN A GLASS FORMING PROCESS

(71) Applicants: Olus Naili Boratav, Ithaca, NY (US); Robert Delia, Horseheads, NY (US); Bulent Kocatulum, Horseheads, NY (US); Shawn Rachelle Markham, Harrodsburg, KY (US); William Anthony Whedon, Corning, NY (US)

(72) Inventors: Olus Naili Boratav, Ithaca, NY (US); Robert Delia, Horseheads, NY (US); Bulent Kocatulum, Horseheads, NY (US); Shawn Rachelle Markham, Harrodsburg, KY (US); William Anthony Whedon, Corning, NY (US)

(21) Appl. No.: 13/686,421

(22) Filed: Nov. 27, 2012

Related U.S. Application Data
(60) Provisional application No. 61/564,062, filed on Nov. 28, 2011.

(51) Int. Cl. C03B 17/06

(52) U.S. Cl. CPC C03B 17/067
USPC 65/84; 65/204

(57) ABSTRACT

Disclosed is an apparatus for producing a glass sheet comprising lower thermal shields positioned below cooling doors for minimizing radiative heat loss from a forming body used to form a ribbon of molten glass from which a glass sheet is cut, and upper thermal shields positioned between the cooling doors and a root of the forming body for minimizing radiative heat loss from the forming body. The thermal shields are typically arranged as pairs and positioned on horizontally opposite sides of a flow of molten glass descending as a continuous ribbon from the forming body. Each thermal shield of the lower and upper thermal shield pairs may comprise a plurality of segments, including end segments and a central segment, wherein the end segments may be separately movable relative to the central segment, allowing an edge of the thermal shield adjacent the ribbon to be varied.

This application claims the benefit of priority under 35 U.S.C. §119 of U.S. Provisional Application Ser. No. 61/564,062 filed on Nov. 28, 2011 the content of which is relied upon and incorporated herein by reference it its entirety.

### TECHNICAL FIELD

This invention is directed to a method of reducing radiative heat loss in a glass making process, and in particular, reducing the radiative heat loss from a wedge-shaped forming body in a fusion down draw process.

### BACKGROUND

The fusion downdraw process is one method used in the glass making art to produce sheet glass. Compared to other processes, e.g., float and slot draw processes, the fusion process produces glass sheets whose surfaces have superior flatness and smoothness without post forming processing (grinding, polishing, etc.). As a result, the fusion process has become of particular importance in the production of the thin glass substrates, such as those used in the manufacture of liquid crystal displays (LCDs), where surface quality must be stringently controlled.

The fusion process, specifically, the overflow downdraw fusion process, is the subject of commonly assigned U.S. Pat. Nos. 3,338,696 and 3,682,609, to Stuart M. Dockerty. As described therein, a glass sheet is formed by overflowing a refractory forming body with a molten glass

In an exemplary fusion downdraw process, a glass melt is supplied to a trough formed in a refractory forming body. The molten glass overflows the top of the trough on both sides of the body to form separate flows of glass that flow downward and then inward along the outer surfaces of the forming body. The two flows meet at the bottom, or root, of the forming body, where they fuse together into a single ribbon of molten glass. The single ribbon of molten glass is then fed to drawing equipment and cools from a viscous liquid at the root to an elastic solid. The thickness of the ribbon at the point where the ribbon achieves a final thickness (in the setting zone) is controlled, inter alia, by the rate at which the ribbon is drawn away from the root by the drawing apparatus and by controlling the temperature (viscosity) of the glass.

During the drawing process, the exterior, outward facing surfaces of the final glass sheet will not have contacted the outside surface of the forming body. Rather, these surfaces are exposed only to the ambient atmosphere. The inner surfaces of the two separate flows that form the ribbon do contact the forming body, but fuse together at the root of the forming body and are thus buried within the body of the final sheet. As a result, the superior properties of the outer surfaces of the final sheet are achieved.

A forming body used in the fusion process is subjected to high temperatures and substantial mechanical loads as the glass melt flows into its trough and over its outer surfaces. To withstand these demanding conditions, the forming body is typically made from an isostatically pressed and sintered block of refractory material. In particular, the forming body may be made from an isostatically pressed zircon refractory, i.e., a refractory composed primarily of ZrO₂ and SiO₂. For example, the forming body can be made of a zircon refractory in which ZrO₂ and SiO₂ together comprise at least 95 wt. % of the material, with the theoretical composition of the material being ZrO₂.SiO₂ or, equivalently, ZrSiO₄. However, it should be noted that similar effects to those described herein for zircon can occur with other refractory materials according to their chemistry.

A source of loss in the manufacture of sheet glass by a downdraw process as described above, and particularly for use as LCD substrates, is the presence of zircon crystal inclusions in the glass (referred to herein as “secondary zircon crystals” or “secondary zircon defects” or simply “secondary zircon”) as a result of the glass passing into and over the zircon forming body. The problem of secondary zircon crystals becomes more pronounced with devitrification-sensitive glasses that need to be formed at higher temperatures. That is, high liquidus temperature glasses may be more prone to the formation of secondary zircon.

Zircon that results in the secondary zircon crystals found in finished glass sheets has been found to originate at the upper portions of the zircon forming body. In particular, these defects ultimately arise as a result of zirconia (i.e., ZrO₂ and/or Zr⁺⁴+2O⁻²) dissolving into the glass melt at the temperatures and viscosities that exist in the forming body's trough and along the upper walls on the outside of the forming body. The temperature of the glass is higher and its viscosity is lower at these upper portions of the forming body as compared to the forming body's lower portions since, as the glass travels down the forming surfaces, it cools and becomes more viscous. This cooling can be increased by the nature of the forming apparatus. In a typical arrangement, the forming body is enclosed in a five-sided box wherein the forming body is surrounded at the top and sides by the box walls. However, the bottom of the box is at least partially open to allow the glass sheet to descend from the forming body (i.e. from the forming body root). As a result, heat is radiated through this opening by the root and areas adjacent the root, and the root subsequently cools.

The solubility and diffusivity of zirconia in a glass melt is a function of the glass temperature and viscosity (i.e., as the temperature of the glass decreases and the viscosity increases, less zirconia can be held in solution and the rate of diffusion decreases). As the glass nears the bottom (root) of the forming body, it may become supersaturated with zirconia as a result of the aforementioned cooling. Zircon crystals (i.e., secondary zircon crystals) can therefore nucleate and grow on the root of the zircon forming body. Eventually these crystals grow long enough to break off into the glass flow and become defects.

### SUMMARY

To control the radiative heat loss from a forming body used to produce glass sheet, thermal shields are described that function to control temperature of the forming body root by minimizing the “view” to the bottom of the forming body from outside the enclosure. That is, by reducing the extent of the line of sight into the enclosure from outside the enclosure, the ability of the forming body, and the molten glass flowing over the forming body, to radiate heat to the outside and thereby cooling the forming body and the molten glass, can be significantly reduced.

More particularly, an exemplary forming body in a fusion downdraw process comprises surfaces that converge at the bottom of the forming body. Molten glass flowing over the sides of the forming body flow over the forming surfaces. The separate flows descending down the forming surfaces fuse at the line of convergence, and form a glass sheet. The thermal shields are typically arranged in pairs, with one thermal shield of a pair of thermal shields positioned proximate one surface of the sheet, while the other shield is positioned proximate the other side of the sheet, thereby forming a narrow opening or slit through which the glass flows. The thermal shields are placed close enough to the surfaces of the glass sheet to minimize significant radiative heat loss, while not so close that contact is made with the flow of molten glass.

Accordingly, in one embodiment, an apparatus for forming a glass sheet is disclosed comprising an enclosure disposed about a forming body, the enclosure comprising an opening below the forming body to allow a flow of molten glass descending from the forming body to pass from the enclosure and cooling doors positioned below the forming body. The apparatus further comprises a first pair of thermal shields positioned below the cooling doors for minimizing radiative heat loss from the forming body, each thermal shield of the first pair of thermal shields comprising at least one segment and being movable relative to the flow of molten glass, wherein each thermal shield of the first pair of thermal shields comprises end portions and a central portion, each of the end portions and the central portion comprising a forward edge relative to the flow of molten glass, and wherein the forward edges of the end portions of each thermal shield of the first pair of thermal shields do not extend closer to a plane of the flow of molten glass than the forward edges of the central portion of each thermal shield of the first pair of thermal shields and a second pair of thermal shields positioned above the cooling doors, each thermal shield of the second pair of thermal shields comprising at least one segment and being movable relative to the flow of molten glass, wherein each thermal shield of the second pair of thermal shields comprises end portions and a central portion, each of the end portions and the central portion comprising a forward edge relative to the flow of molten glass and wherein the forward edges of the end portions of each thermal shield of the second pair of thermal shields do not extend closer to a plane of the flow of molten glass than the forward edge of the central portion of each thermal shield of the second pair of thermal shields.

The cooling doors comprise face members arranged in an opposing relationship to the flow of molten glass. In some embodiments the face members are vertical. In other embodiments the face members are angled in relation to vertical. A portion of the face members closest to an adjacent surface of the flow of molten glass is preferably less than 10 cm from the adjacent surface.

In another embodiment, an apparatus for forming a glass sheet is described comprising an enclosure disposed about a forming body, the enclosure comprising an opening below the forming body to allow a flow of molten glass descending from the forming body to pass from the enclosure and cooling doors positioned below the forming body. The apparatus further comprises a first pair of thermal shields positioned below the cooling doors for minimizing radiative heat loss from the forming body, each thermal shield of the first pair of thermal shields comprising at least one segment and being movable relative to the flow of molten glass, wherein each thermal shield of the first pair of thermal shields comprises end portions and a central portion, each of the end portions and the central portion comprising a forward edge relative to the flow of molten glass, and wherein the forward edges of the end portions of each thermal shield of the first pair of thermal shields do not extend closer to a plane of the flow of molten glass than the forward edges of the central portion of each thermal shield of the first pair of thermal shields, and a second pair of thermal shields positioned above the cooling doors, each thermal shield of the second pair of thermal shields comprising at least one segment and being movable relative to the flow of molten glass, wherein each thermal shield of the second pair of thermal shields comprises end portions and a central portion, each of the end portions and the central portion comprising a forward edge relative to the flow of molten glass and wherein the forward edges of the end portions of each thermal shield of the second pair of thermal shields do not extend closer to a plane of the flow of molten glass than the forward edge of the central portion of each thermal shield of the second pair of thermal shields. A first distance between the forward edge of the central portion of a thermal shield of the first pair of thermal shields and an adjacent surface of the flow of molten glass is in a range from about 3 cm to about 9 cm and a second distance between the forward edge of the central portion of a thermal shield of the second pair of thermal shields from the adjacent surface of the flow of molten glass is in a range from about 3 cm to about 23 cm.

In one embodiment, at least a portion of the forward edges of the end portions are recessed relative to the forward edge of the central portion.

The cooling doors comprise face members arranged in an opposing relationship to the flow of molten glass. In some embodiments the face members are vertical. In other embodiments the face members are angled in relation to vertical. A portion of the face members closest to an adjacent surface of the flow of molten glass is preferably less than 10 cm from the adjacent surface.

In still another embodiment, a method of forming glass by a downdraw method is disclosed comprising flowing molten glass over a forming body, the molten glass descending from the forming body in a continuous ribbon, there being a pair of opposing cooling doors positioned below the forming body, each cooling doors comprising a plurality of gas outlets for directing a cooling gas against face members of the cooling doors. The method further comprises positioning a first pair of thermal shields disposed below the cooling doors for minimizing radiative heat loss from the forming body, each thermal shield of the first pair of thermal shields comprising at least one segment and being movable relative to the flow of molten glass, wherein each thermal shield of the first pair of thermal shields comprises end portions and a central portion, each of the end portions and the central portion comprising a forward edge relative to the flow of molten glass, and wherein the forward edges of the end portions of each thermal shield of the first pair of thermal shields do not extend closer to a plane of the flow of molten glass than the forward edge of the central portion of the first pair of thermal shields.

The method may also include positioning a second pair of thermal shields disposed above the cooling doors, each thermal shield of the second pair of thermal shields comprising at least one segment and being movable relative to the flow of molten glass, wherein each thermal shield of the second pair of thermal shields comprises end portions and a central portion, each of the end portions and the central portion comprising a forward edge relative to the flow of molten glass and wherein the forward edges of the end portions of each thermal shield of the second pair of thermal shields do not extend closer to a plane of the flow of molten glass than the forward edge of the central portion of the second pair of thermal shields. After positioning the first and second pairs of thermal shields, a first distance between the forward edge of the central portion of a thermal shield of the first pair of thermal shields and an adjacent surface of the flow of molten glass is in a range from about 3 cm to about 9 cm and a second distance between the forward edge of the central portion of a thermal shield of the second pair of thermal shields from the adjacent surface of the flow of molten glass is in a range from about 3 cm to about 23 cm.

The method may further comprise positioning a portion of the face members closest to an adjacent surface of the flow of molten glass less than 10 cm from the adjacent surface.

In yet another embodiment, a method of drawing glass from a glass drawing apparatus is disclosed comprising flowing separate streams of molten glass over converging forming surfaces of a forming body, the separate streams of molten glass joining at a bottom of the forming body to form a ribbon of molten glass and selecting a predetermined temperature profile along a length of the glass drawing apparatus. The predetermined temperature profile may be determined by modeling or by experimental analysis. The temperature profile represents the profile necessary to obtain a desired set of glass characteristics based on such factors as stress and compaction, for example, and may vary with glass type, molten glass flow rate, glass composition, and so forth.

The method may further comprise positioning a first thermal shield wherein a forward edge of the thermal shield is in a range from about 3 cm to about 9 cm from a surface of the ribbon of molten glass, positioning a second thermal shield wherein a forward edge of the thermal shield is in a range from about 3 cm to about 23 cm from the bottom of the forming body; and positioning a cooling door located between the first and second thermal shields wherein a face of the cooling door at its closest approach to the ribbon of molten glass is less than about 10 cm from an adjacent surface of the ribbon of molten glass.

These and other embodiments will be understood more easily and other objects, characteristics, details and advantages thereof will become more clearly apparent in the course of the following explanatory description, which is given, without in any way implying a limitation, with reference to the attached Figures. It is intended that all such additional systems, methods, features and advantages be included within this description, be within the scope of the present invention, and be protected by the accompanying claims.

### BRIEF DESCRIPTION OF THE DRAWINGS

FIG. 1 is a perspective view and partial cross sectional side view of an exemplary forming body in a fusion downdraw glass melting process in accordance with an embodiment of the present invention.

FIG. 2 is a cross sectional side view of an exemplary fusion forming apparatus according to an embodiment of the present invention comprising the forming body of FIG. 1 with thermal shields positioned below the cooling members.

FIG. 3 is a cross sectional view of a portion of the forming apparatus of FIG. 2.

FIG. 4A is a top view of a thermal shield having a single segment according to an embodiment of the present invention.

FIG. 4B is a top view of a pair of thermal shields of FIG. 4A with a cross section of a sheet of glass positioned therebetween.

FIG. 5A is a top view of a thermal shield having a single segment according to an another embodiment of the present invention

FIG. 5B is a top view of a pair of thermal shields of FIG. 5A with a cross section of a sheet of glass positioned therebetween.

FIG. 6A is a top view of a thermal shield having a single segment according to still another embodiment of the present invention.

FIG. 6B is a top view of a pair of thermal shields of FIG. 6A with a cross section of a sheet of glass positioned therebetween.

FIG. 7A is a top view of a thermal shield having a multiple segments according to an embodiment of the present invention.

FIG. 7B is a top view of a pair of thermal shields of FIG. 8A with a cross section of a sheet of glass positioned therebetween.

FIG. 8A is a top view of a thermal shield having a multiple segments according to another embodiment of the present invention.

FIG. 8B is a top view of a pair of thermal shields of FIG. 9A with a cross section of a sheet of glass positioned therebetween.

FIG. 9 is a cross sectional side view of a portion of a thermal shield segment showing a layered construction.

FIG. 10 is a top view of a portion of a thermal shield segment showing expansion slots.

FIG. 11A is a schematic showing the effect of a single thermal shield on forming body root temperature.

FIG. 11B is a schematic showing the effect of a single thermal shield on forming body root temperature.

FIG. 12A is graph showing forming body root temperature as a function of distance between the forward edges of the central portions of the lower thermal shields (LTS) from adjacent surfaces of the glass ribbon.

FIG. 12B is graph showing force factor as a function of distance between the forward edges of the central portions of the lower thermal shields (LTS) from adjacent surfaces of the glass ribbon.

FIG. 13A is graph showing forming body root temperature as a function of distance between the forward edges of the central portions of both the lower thermal shields (LTS) and the upper thermal shields (UTS) from adjacent surfaces of the glass ribbon.

FIG. 13B is graph showing force factor as a function of distance between the forward edges of the central portions of both the lower thermal shields (LTS) and the upper thermal shields (UTS) from adjacent surfaces of the glass ribbon.

FIG. 14 is graph comparing the relative operating space using a single pair of thermal shields vs. two pair of thermal shields;

FIG. 15 is a graph showing curves indicating actual thickness data of a molten glass ribbon, calculated thickness after modification, and a sliding window average of thickness indicative of thickness uniformity using only a single pair of thermal shields.

FIG. 16 is a graph showing curves indicating actual thickness data of a molten glass ribbon, calculated thickness after modification, and a sliding window average of thickness indicative of thickness uniformity using two pair of thermal shields.

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

In an exemplary fusion downdraw process for making a glass sheet in accordance with embodiments disclosed herein, glass forming precursors (batch) are melted in a furnace to form a molten raw material, or glass melt, which is thereafter flowed over a forming body to form the glass sheet. Generally, such forming bodies include exterior forming surfaces over which the melt flows. For example, in a fusion downdraw sheet forming process the melt flows over forming surfaces that intersect at the bottom of the forming body. The forming surfaces comprise inclined or converging forming surfaces that converge at the bottom (i.e. root) of the forming body to form a wedge shape. Upper forming surfaces, when present, may be substantially vertical and parallel with one another.

The design of the forming body must take into consideration a number of competing interests. Molten raw material (i.e. molten glass) is introduced into a trough in the forming body bounded at its sides by dams (weirs). The molten raw material must be introduced to the forming body at a viscosity low enough, that is, at a high enough temperature, to produce an even flow of glass melt over the tops of the weirs (upper walls bounding the trough). The molten raw material then flows down the exterior forming surfaces of the forming body, including the converging forming surfaces, to the bottom of the body.

On the other hand, the molten raw material leaving root of the forming body must have a viscosity high enough—at a low enough temperature—to allow the molten raw material to be drawn successfully, yet not so low that the viscosity of the molten raw material falls below the liquidus viscosity of the molten raw material, which can cause the glass melt to crystallize.

If the glass melt overflowing the forming body remains at a high temperature for too long a time as it descends the forming surfaces, the material comprising the forming body may dissolve, then re-crystallize as “secondary zircon” at a lower, colder portion of the forming body, such as the root. Secondary zircon crystals may grow long enough to break off and become entrained in the glass flow, resulting in a defect in the finished glass product.

Entrained crystals can be particularly troublesome because the root is proximate an opening at the bottom of the enclosure housing the forming body through which the molten glass exits the enclosure. The molten glass consequently loses heat by radiation through the opening. Since the opening is necessary, efforts must be undertaken to mitigate radiative heat loss from the forming body, and especially from the forming body root. One approach is to heat the root to make up for the heat loss, but this is only partially effective. Moreover, the additional heat energy applied to the root flows upward via convection, and may increase the temperature of the upper portions of the forming body. An increased temperature at the top of the forming body may in fact prove counter productive, as the increased upper temperature can lead to increased dissolution of the forming body itself, exacerbating a secondary zircon problem. It can also change the delicate balance between the upper and lower viscosity of the glass needed to draw quality glass (the viscosity at the top of the forming body and the viscosity at the bottom of the forming body). It should be noted that the mechanism for formation of secondary zircon is applicable to the dissolution and condensation of other forming body materials and not limited to zirconia.

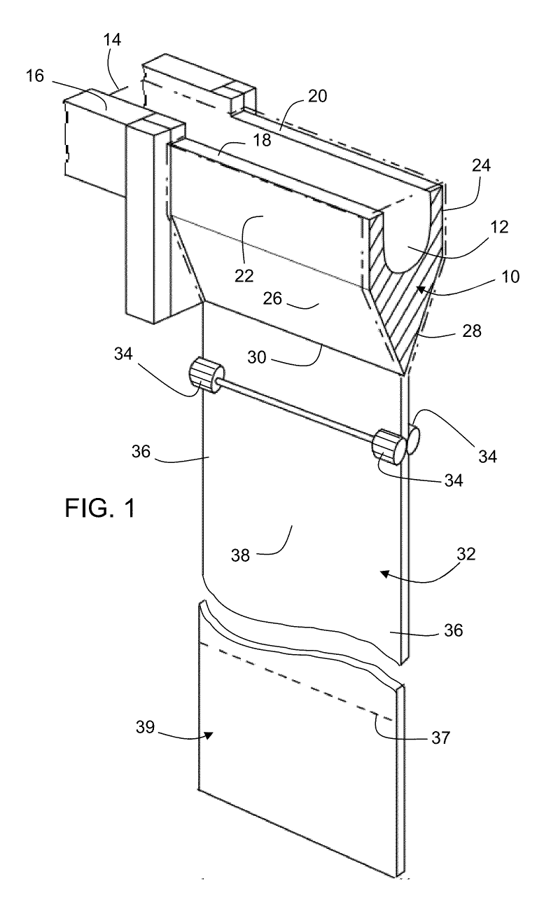

FIG. 1 depicts an exemplary forming body 10 according to one embodiment. Forming body 10 comprises trough 12 for receiving molten glass 14 from a supply (not shown). Forming body 10 further comprises inlet 16, weirs 18, 20, upper forming surfaces 22, 24 and lower converging forming surfaces 26, 28. Lower converging forming surfaces 26, 28 intersect at the bottom or root 30 of the forming body. Root 30 forms a draw line, or a line from which the glass sheet is drawn from the forming body.

Molten glass 14 supplied to forming body 10 overflows weirs 18, 20, and flows down forming surfaces 22, 24 and 26, 28 as two distinct flows, one flow descending down each side of the forming body. Thus, one flow descends over forming surfaces 22 and 26 while the other flow descends over converging forming surfaces 24, and 28. The two flows of molten glass re-unite or fuse at root 30 to form glass ribbon 32 that is drawn downward by pulling equipment, represented by pulling rolls 34. Surface tension causes edge portions 36 of the glass ribbon to become thicker than the inner portion 38 of the glass ribbon. The thicker edge portions, or beads, are gripped by the pulling rolls disposed downstream of the forming body, the pulling rolls exerting a downward pulling force on the glass sheet. The inner portion 38 of the glass ribbon inward of the beads is the region that subsequently becomes the saleable glass, whereas the edge portions 36 are typically cut from the glass and discarded, or used as cullet and added to the batch materials in the melting process. The descending glass ribbon 32 is eventually separated at cutting line 37 into individual glass panes 39.

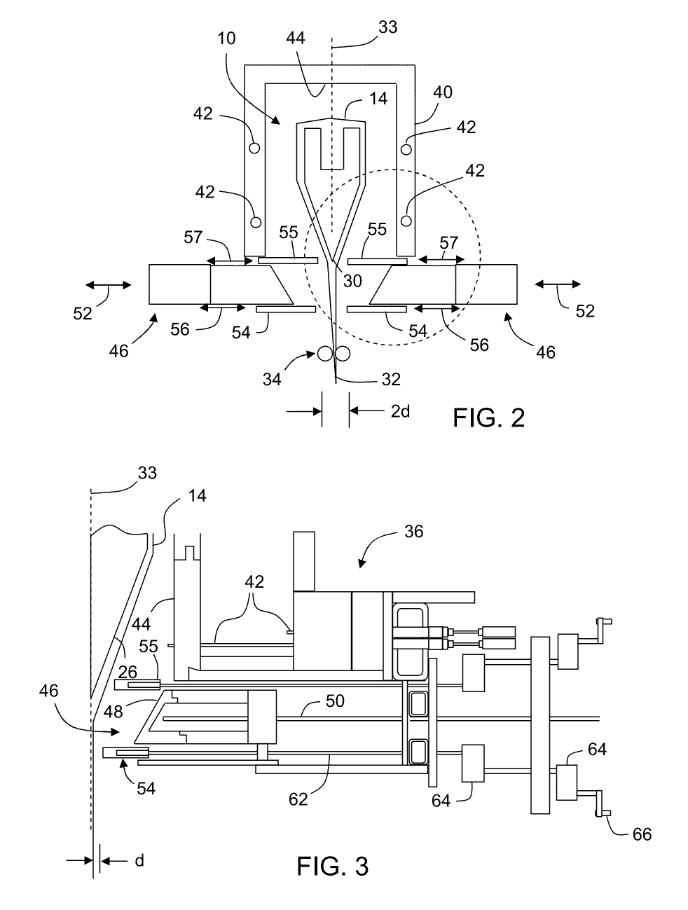

Forming body 10 is typically comprised of a ceramic refractory material, such as zircon or alumina and housed in enclosure 40 (see FIG. 2). Enclosure 40 comprises heating elements 42 arranged behind interior walls (muffle 44). The heating elements are used to control the temperature of the molten glass on the forming surfaces of the forming body, and hence the viscosity of the molten glass, and may be arranged throughout the enclosure as needed. Typically, the heating elements are in banks arranged vertically so that the temperature within the enclosure can be controlled as a function of vertical position in the enclosure.

Cooling doors 46 are located below enclosure 40 and may be movable so that the cooling doors can be positioned an appropriate distance from descending glass ribbon 32, and are best seen with the aid of FIG. 3 showing a portion of FIG. 2 surrounded by the dashed circle. Dashed line 33 represents a vertical plane bisecting the forming body and passing through root 30 and the flow of molten glass ribbon 32. Cooling doors 46 contain cooling equipment that cools surfaces of the cooling doors and in particular the faces 48 of the cooling doors. Cooling of the cooling door faces 48 in turn controls the temperature and therefore the viscosity of the glass descending from the forming body along the width of the glass (e.g. horizontally). For example, the cooling doors may contain one or more coolant supply lines 50 and outlets that extend along the length of the cooling doors. Each outlet emits a coolant (typically air) that cools a portion of each cooling door face 48 adjacent to the outlet. The volume of coolant emitted by each outlet may be individually controlled so that the temperature of the cooling door face can be controlled as a function of location on the face (e.g. horizontal location). In some embodiments, a single supply line may feed a header comprising a plurality of outlets, each outlet being controlled by a remotely controlled valve.

It should be apparent from the preceding that the cooling doors rely on thermal diffusion for their operation. That is, the effect of the individual cooling outlets is smoothed over the expanse of the cooling door faces. While this can be an advantage by preventing large, discrete viscosity changes from one location across the width of the glass ribbon to another adjacent location, it may also limit the spatial resolution of the apparatus. In other words, the thermal smoothing effect produced by the cooling door faces prevents small modifications of the glass ribbon viscosity over short distances. In a conventional fusion downdraw apparatus, the lack of sufficient spatial resolution is exacerbated by the minimum distance between the cooling door face and the adjacent surface of the glass ribbon.

The cooling arrangement described above allows the cooling door faces 48 to vary the temperature and viscosity of the glass descending from the forming body as a function of location across the width of the glass sheet, and can be used, for example, to control the across-the-sheet thickness of the glass. While the cooling doors are capable of horizontal translation (represented by arrows 52) to enable positioning the cooling doors relative to the major surfaces of the glass ribbon, once an optimum position is set, the cooling doors are seldom moved during the drawing process, since such movement can affect ribbon attributes (e.g. shape, thickness, etc.). Rather, functionality of the cooling doors is derived largely by controlling the flow of coolant to the cooling doors, and therefore the temperature of the cooling door faces. The optimum position depends on the particular draw setup, and may vary from draw to draw. However, in a conventional fusion downdraw process, the cooling doors extend no closer than 4 inches (10.16 cm) to an adjacent surface of the glass ribbon to avoid contact with molten glass that may become disassociated from the body of molten glass flowing over the forming body. A covering of molten glass on the faces of the cooling doors reduces the effectiveness of the cooling doors for localized cooling of the molten glass ribbon.

To provide finer control of the thermal environment within enclosure 40, and in particular the temperature of the root 30 of the forming body, thermal shields 54 are positioned adjacent cooling doors 46, specifically below the cooling doors, to control radiative heat loss from the forming body, and in particular radiative heat loss from the root region of the forming body. Similarly, thermal shields 55 are positioned above cooling doors 46. Thermal shields 54 and 55 are arranged as pairs, such that thermal shields 54 comprise two opposing thermal shields positioned on opposite sides of glass ribbon 32 below cooling doors 46. Likewise, thermal shields 55 also comprise two opposing thermal shields positioned on opposite sides of glass ribbon 32 above cooling doors 46. Thermal shields 54 and 55 may be independently movable. That is, in some embodiments one thermal shield of a thermal shield pair (i.e. thermal shields 54 or 55) is movable independently from the opposing thermal shield (on the other side of the ribbon), and like the cooling doors, is capable of horizontal movement, being extendable toward the glass ribbon, and retractable, away from the glass ribbon. Movement toward or away from the ribbon can be provided for in several ways. Thermal shields 54 may be positioned such that a plane of thermal shields 54 is at least about 10 cm from root 30 of the forming body. Thermal shields 55 may be positioned such that when closed, thermal shields 55 just clear root 30. That is, a horizontal plane of the thermal shields 55 is no more than about 1 cm below the root of the forming body.

As can be appreciated by the above description, both cooling and heating can occur simultaneously in regions quite close to each other. Thermal shields 54 and 55 minimize radiate heat loss from the bottom of the forming body to prevent cooling of the molten glass at the root of the forming body, whereas cooling doors 46 are used to actively cool the glass across a width of the descending ribbon as an aid to thickness control. Indeed, the operation of cooling doors 46 and thermal shields 54 and 55 can be coordinated to maintain a specific thermal environment in proximity to the forming body. As discussed in more detail below, the utilization of two pair of thermal shields, one pair above cooling doors 46 and one pair below cooling doors 46 provide flexibility for management of the thermal environment above and below the root of the forming body. In addition, positioning of thermal shields above the cooling doors protects the faces of the cooling doors, allowing the cooling doors to be moved closer to the molten glass ribbon without encountering molten glass or other debris from above, thereby increasing the spatial resolution of the cooling doors upon the glass ribbon.

As shown in FIG. 2, and noted above, movement of the thermal shields can be performed horizontally, wherein the thermal shields translate toward or away from the glass ribbon to increase or decrease the gap between the thermal shields. Such horizontal movement for thermal shields 54 and 55 is represented by arrows 56 and 57, respectively.

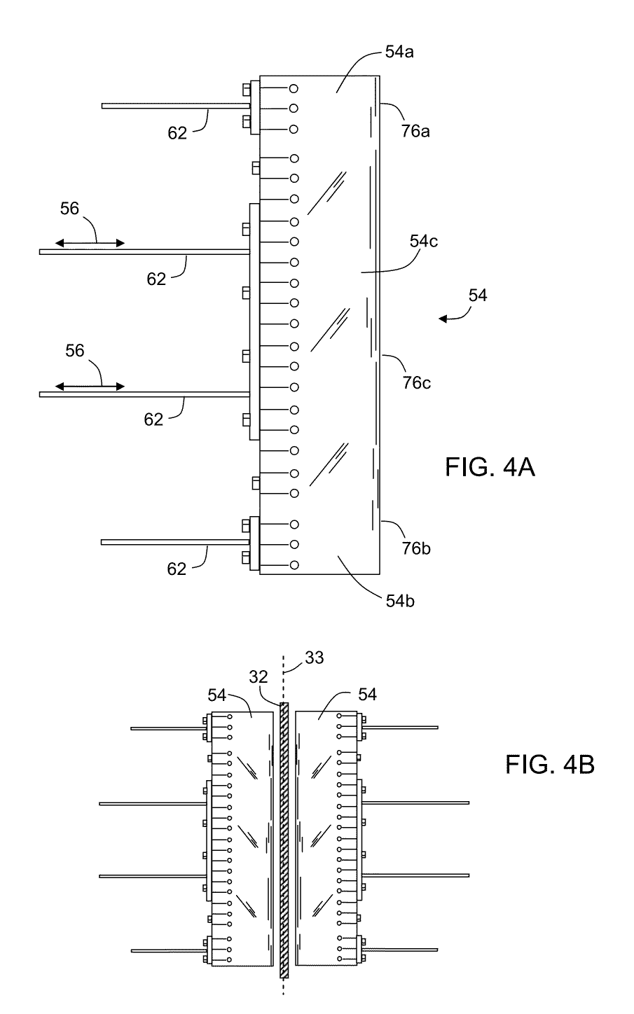

Each thermal shield may comprise a single segment, or a plurality of segments. In the following FIGS. 4A-10, reference will be made to thermal shields 54. However, the following descriptions are equally applicable to thermal shields 55.

In one embodiment illustrated in FIG. 4A, each thermal shield 54 comprises a single segment comprising end portions 54a, 54b and a central portion 54c. The forward edges 76a, 76b of the end portions may be in line with forward edge 76c of central portion 54c, but may be recessed such that the forward edge of the end portions are farther from the plane of the flow of molten glass than the forward edge of the central portion. FIG. 4B depicts a pair of thermal shields of FIG. 4A with a cross sectional view of a ribbon of glass passing between the thermal shields.

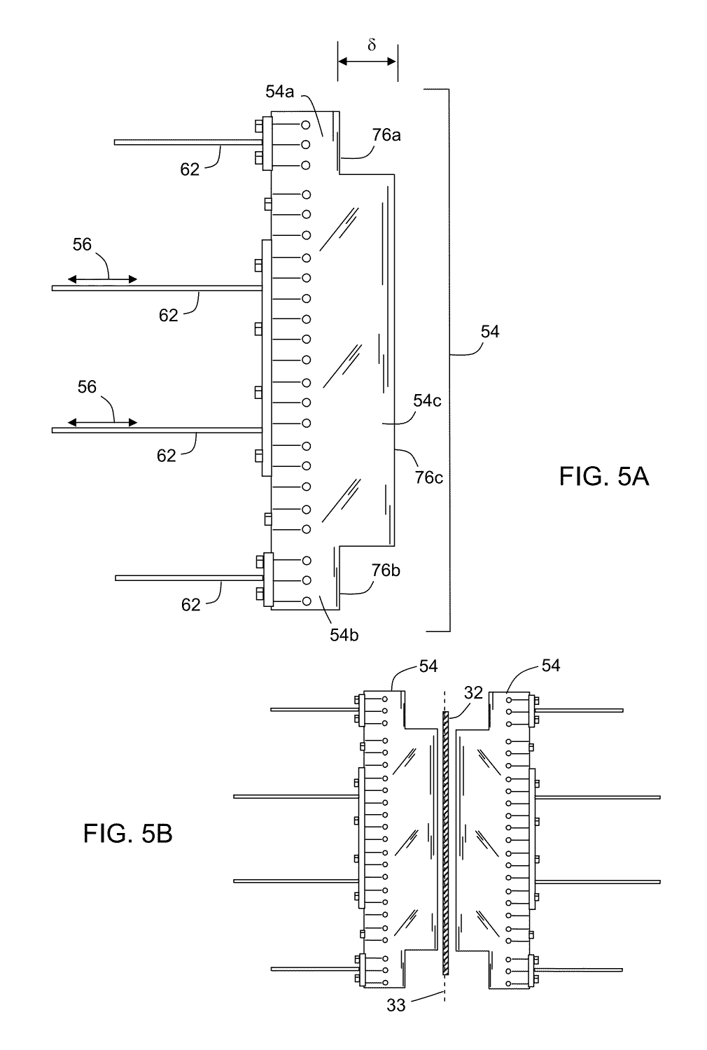

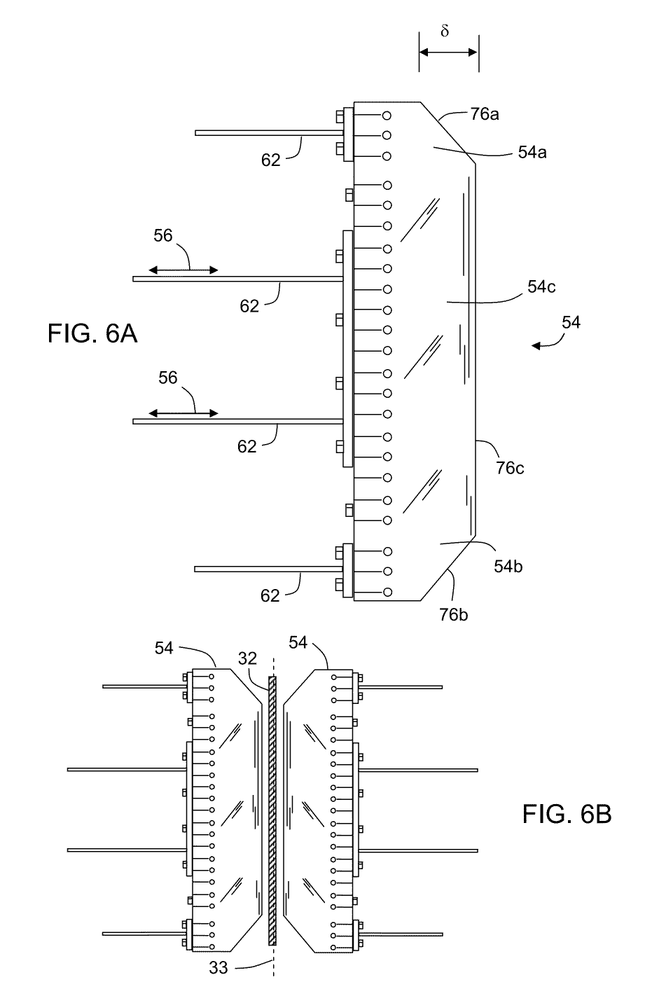

FIGS. 5A and 6A depict alternative embodiments of the single segment thermal shield and illustrate recessed end portions. For example, FIG. 5A shows an embodiment wherein the forward edge portions 76a, 76b of each of the end portions 54a, 54b are recessed behind forward edge portion 76c of central portion 54c by distance 6. In this embodiment, each of the forward edge portions 76a-76c is parallel with the other forward edge portions.

FIG. 6A depicts an embodiment wherein the forward edges 76a, 76b of end portions 54a, 54b, respectively are both recessed and angled relative to the forward edge 76c of the central portion 54c. Other configurations may also be employed, such as wherein the forward edges of the end portions comprise a curved edge.

FIGS. 5B and 6B depict a pair of thermal shields of FIGS. 5A and 6A, respectively, with a cross sectional view of a ribbon of glass passing between the thermal shields.

In other embodiments, each thermal shield may comprise a plurality of segments or blades. Each segment of each thermal shield may be moveable independently from an adjacent segment. As each thermal shield is essentially identical to the other (opposite) shield in construction, reference will be made to a single thermal shield, with the understanding that the description applies to the corresponding opposite thermal shield (i.e. the thermal shield positioned on the opposite side of the descending ribbon).

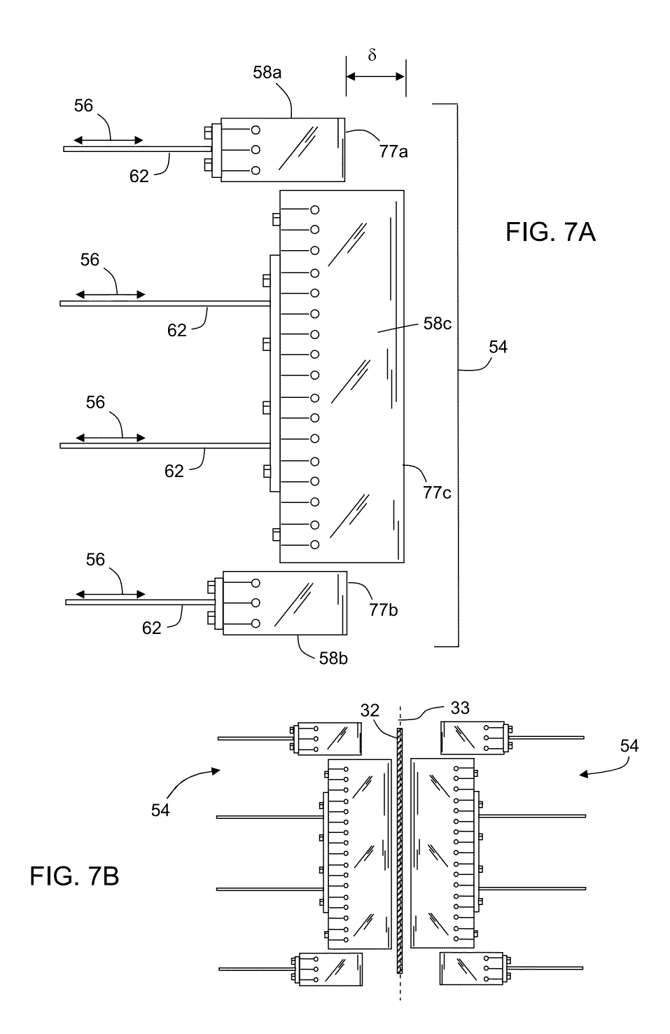

FIG. 7A depicts an embodiment of an exemplary segmented thermal shield 54. Segmented thermal shield 54 comprises one or more segments, e.g. end members 58a, 58b and central member 58c. End member 58a, 58b may be separately movable relative to central member 58c. In addition, end member 58a may be separately movable from end member 58b, although typically end members 58a, 58b are moved in unison, and may also be moved in unison with central member 58c. Movement can be accomplished by a number of methods. For example, each segment of the thermal shield may be connected via an appropriate linkage 62 (e.g. shaft or shafts 62) and/or gearbox or gearboxes 64 to an actuator 66 that can be manipulated to cause the section or sections to extend inward, toward the glass ribbon, or to retract outward, away from the glass ribbon (see FIG. 3). For example, actuator 66 may be a simple hand crank or lever, or the actuator may be an electric motor or servo, and if preferred, controlled via a computer or other electronic processor. FIG. 7B depicts a pair of thermal shields of FIG. 7A as the shields would be deployed with a cross sectional view of a ribbon of glass passing between the thermal shields.

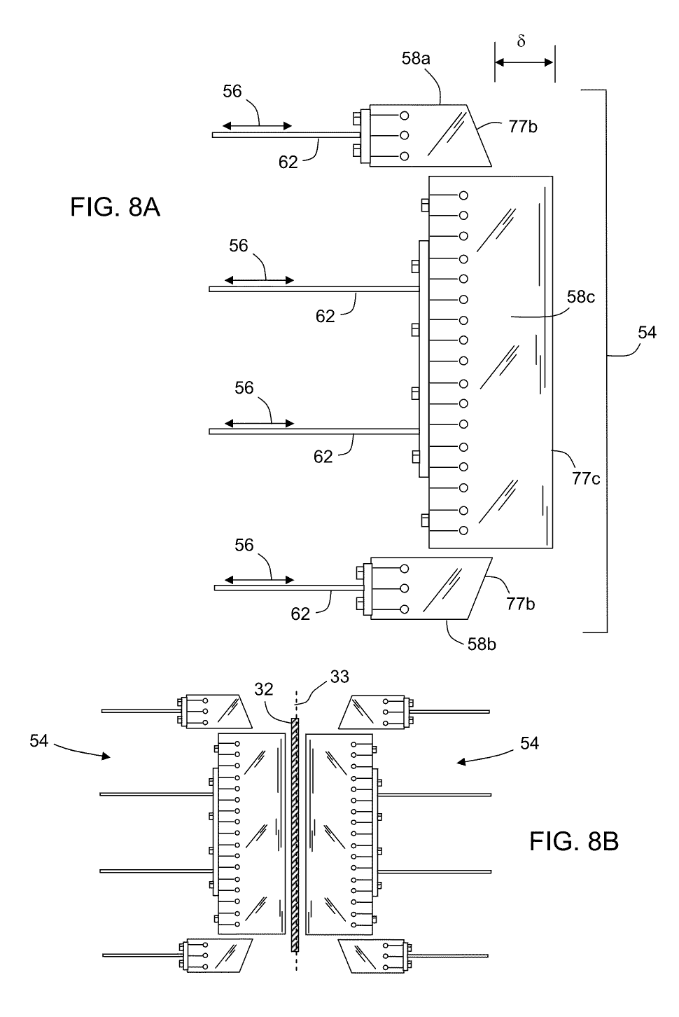

FIG. 8A illustrates a multi-segment thermal shield 54 similar to the thermal shield of FIG. 7A, except that end members 58a, 58b comprise forward edges 76a, 76b that are both angled and recessed relative to forward edge 76c of central member 58c. FIG. 8B depicts a pair of thermal shields of FIG. 8A with a cross sectional view of a ribbon of glass passing between the thermal shields.

As described briefly above, the drawing of glass ribbon via a fusion downdraw process utilizes precise control of the thermal environment surrounding the glass as it descends from the forming body. To that end, each thermal shield may include features to maintain the dimensional integrity of the thermal shields. Variations in the shape or position of a thermal shield could otherwise vary process temperatures. For example, warping of any part of the thermal shield can cause an upset in the thermal environment.

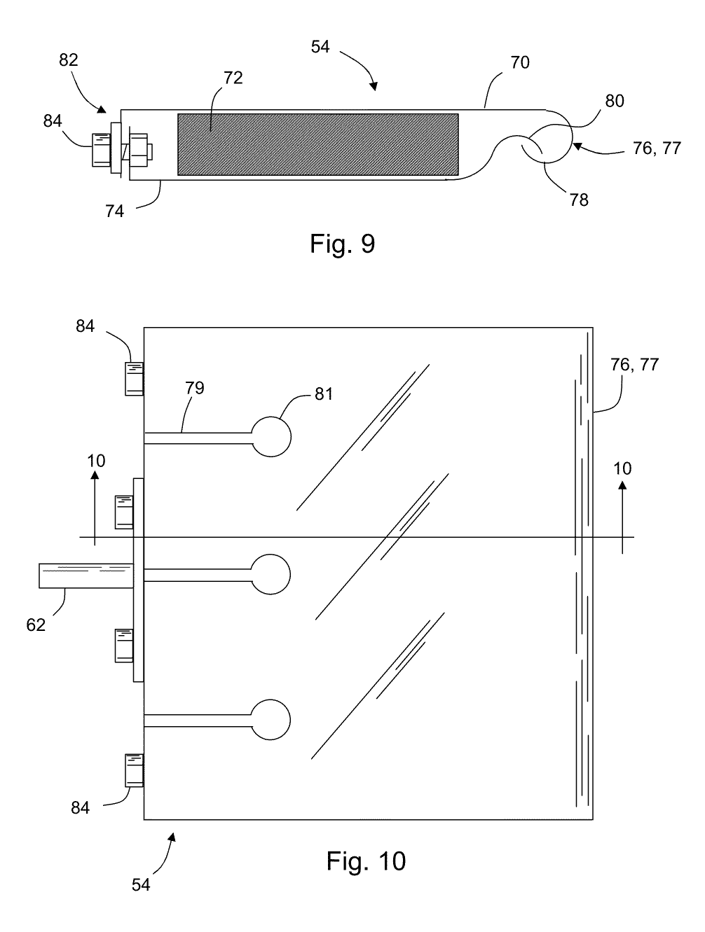

As shown in FIG. 9 depicting a portion of a thermal shield segment in cross section, each segment of thermal shield 54, either a single segment shield or a multiple segment shield, may itself be formed by a plurality of members: upper member 70, an insulating middle layer (insulating member 72) and a lower member 74. The upper and lower members 70, 74 are coupled along front or forward edge 76 (i.e. the edge closest to the flowing glass) via interlocking bends 78, 80 formed in the upper and lower members respectively. The interlocking bends have several purposes. Foremost, they join the upper and lower segments. However, they also aid in stiffening the forward edge 76 of each portion or segment and prevent warping of the edge. Even a small amount of warping can be detrimental to the process by varying slightly the location of the thermal shield edge relative to the glass ribbon. However, the central member of each embodiment comprises a straight (linear) forward edge.

As illustrated in FIG. 10, each of the upper members 70 and lower members 74 of the end segments and the central segment may comprise expansion slots 79 to facilitate expansion of the upper and lower members without leading to warping of the individual portions or segments. Each expansion slot may also terminate at a cutout 81, such as a circular cutout, to prevent stress fractures of the members at the ends of the slots.

Upper and lower members 70, 74 can also be connected along the back edge 82. As shown in FIG. 9, the connection along back edge 82 may be via fasteners 84, such as bolts, arranged along the edge. However, other methods of fastening the upper and lower members along the back edge may also be employed, for example, by welding. Because the thermal shield is deployed in a high temperature environment (the temperature at the upper member may be about 1000° C. and the temperature at the lower member may be about 900° C.), the upper and lower members should be constructed from a material resistant to high temperature and oxidation to ensure an adequate lifetime. For example, upper members 70 and lower members 74 may comprise one or more high temperature metal alloys such as Haynes® Alloy No. 214 or Haynes® Alloy No. 230. An insulating material, such as Fiberfrax® Durablanket® 2600 for example, is a suitable insulating material for insulating layer 72. Since the upper member is typically exposed to higher temperatures than the lower member, the upper member may be formed from a material having a greater resistance to heat and oxidation than the lower member. Although a typical temperature difference across the thickness of the thermal shields is about 100° C., the temperature difference may be greater than 100° C.

The temperature of the glass melt flowing down forming surfaces 22, 24 is substantially constant. On the other hand, forming surfaces 26, 28 are exposed to the cooler temperatures below the forming body. That is, the forming surfaces 26, 28 have a horizontal component to their orientation as well as a vertical component. Thus, the molten glass flowing over forming surfaces 26, 28 cools as it descends the forming surfaces. The lowest portions of the forming body, e.g. the root and the areas adjacent the root have a “view” to the opening at the bottom of the enclosure and radiate heat through the opening that undesirably cools the root and the molten glass at the root. That is, they have a direct line-of-sight through the opening.

As described above, to prevent disruption to the thermal environment surrounding the quality region of the glass ribbon (the saleable portion previously described), front edge 76 of central member 54c, 58c of the various configurations of the thermal shields is a straight, flat edge. It is preferred that the forward edge of the central segment (or portion) extends at least across the quality portion of the glass ribbon to ensure a consistent thermal environment across the width of the ribbon. In operation, the forward edges 76a and 76b of end members 54a, 54b or 58a, 58b are typically recessed a distance δ behind the forward edge 76c or 77c of the central segment 54c or 58c, respectively. The positioning of end members 54a, 54b or 58a, 58b and their respective forward edges farther from the glass ribbon than the central segment both accommodates an increased thickness of the bead regions of the glass ribbon, and can also provide additional clearance for the forming body itself. The distance δ is determined separately for each draw depending on the particular design, the set up of the forming body and draw equipment, and the composition of the glass being drawn. Similarly, the distance d between forward edge 76c or 77c of the central section and the surface of the glass ribbon should be selected to minimize heat loss from the enclosure, while at the same time preventing disruption to the flow of the glass ribbon, and is typically dependent on the particular operating conditions of each individual forming body, the associated draw equipment and the glass composition.

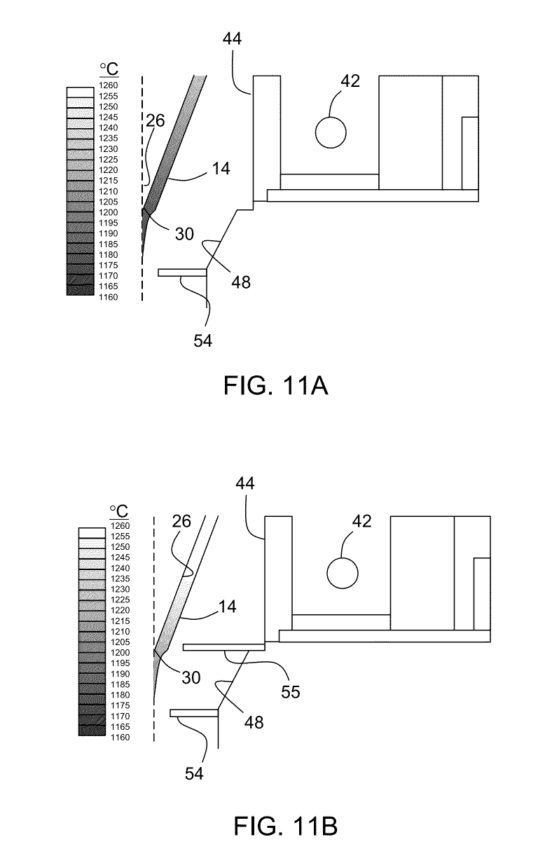

The use of both lower thermal shields 54 and upper thermal shields 55 lends considerable versatility to the fusion forming apparatus that is lacking from a similar apparatus employing only a single, lower set of thermal shields or a single, upper set of thermal shields. FIG. 11A depicts modeled temperatures for an exemplary fusion forming apparatus, and in particular, temperatures of the glass flowing over converging forming surface 26 near the root of the forming body. In accordance with the setup illustrated in FIG. 11A, a temperature at the forming body root with a single thermal shield 54 positioned below a cooling door 46 such that the forward edge of the thermal shield is approximately 3.2 cm from the adjacent surface of the flow of molten glass is about 1180° C. With the lower thermal shield maintained at its former position, and by adding a second thermal shield 55 in an upper position above cooling door 46 (e.g. above cooling door face 48) at a position wherein the forward edge of the thermal shield 55 is about 5.7 cm from the adjacent surface of the flow of molten glass, the root temperature is raised to approximately 1220° C., an approximately 40° C. increase in root temperature, as shown in FIG. 11B.

One aspect of cooling doors 46 is to control the thickness of the glass ribbon across a width of the glass ribbon by locally cooling one region of the ribbon differently than another region of the ribbon. That is, there may be differences in the temperature distribution across a width of the viscous ribbon. This temperature differential can result in a non-uniform thickness of the ribbon. To mitigate this effect, various regions of the glass ribbon can be locally cooled to affect the local thickness, thereby counteracting the thickness non-uniformity. Of course, cooling the viscous glass ribbon so close to the root of the forming body has the unwanted effect of cooling the forming body root, and regions of the forming body converging forming surfaces 26, 28 adjacent to the root. This may in turn have unwanted effects on the forming operation.

A common intent in fusion forming processes is to avoid all types of crystallization (or devitrification) build-up on the forming body. Devitrification can accumulate when the glass temperature falls sufficiently below its liquidus temperature while flowing on these solid surfaces where glass residence time is relatively long near the solid-glass interface. Simply raising the root temperature (via a power source located nearby or by further closing the lower thermal shields) to be above the liquidus temperature is often not an option if raising the root temperature would cause too large a reduction in the force factor, F_{f}, required at root 30 to stretch the glass layer to its final desired thickness. If F_{f} is too low then a situation occurs where the ribbon weight between the root and the pulling rolls contributes more force than is needed to accomplish the desired stretching. The result is a deviation from planarity of the ribbon known as baggy warp.

For example, certain glass compositions, particularly glass compositions suitable for use in display applications, have high liquidus temperatures. If the temperature of the glass falls below the liquidus temperature, there is a danger that devitrification of the glass can occur, thereby seeding the glass with crystals. Thus, controlling the thickness of the glass ribbon by preferentially cooling the ribbon in the vicinity of the root comes at the cost of a reduced root temperature. Utilizing a second pair of thermal shields between the cooling doors and the root can mitigate this cooling effect on the root and adjacent converging forming surfaces. Accordingly, the temperature of the glass flow proximate the root increases, while the temperature of the glass flow below the root is decreased.

For typical glasses suitable for drawing in a fusion method the force F required at the root to facilitate stretching the glass ribbon to its final desired thickness is given by the following formula:

$$F = \frac{4 Q ln \frac{{t}_{0}}{t}}{{\int }_{{y}_{0}}^{y} \frac{d y}{μ}} , \qquad ( 1 )$$

Where F is the sum of any mechanical force (typically supplied by pulling rolls located below the isopipe root) plus the force supplied by the weight of the glass ribbon between the root and the pulling rolls. The force F required to stretch the same glass flowing at the same volumetric rate (Q) to the same final thickness (t) but with different temperature profiles starting at the root (or y₀) and ending at the point where the final thickness is set (y) depends only on the integral term in the denominator above and the natural log term containing the initial thickness (t₀). The initial thickness t₀ is a weak function of temperature and can be neglected for these purposes. As such a force factor F_{f} can be derived as:

$${F}_{f} = \frac{1}{{\int }_{{y}_{0}}^{y} \frac{d y}{μ}} , \qquad ( 2 )$$

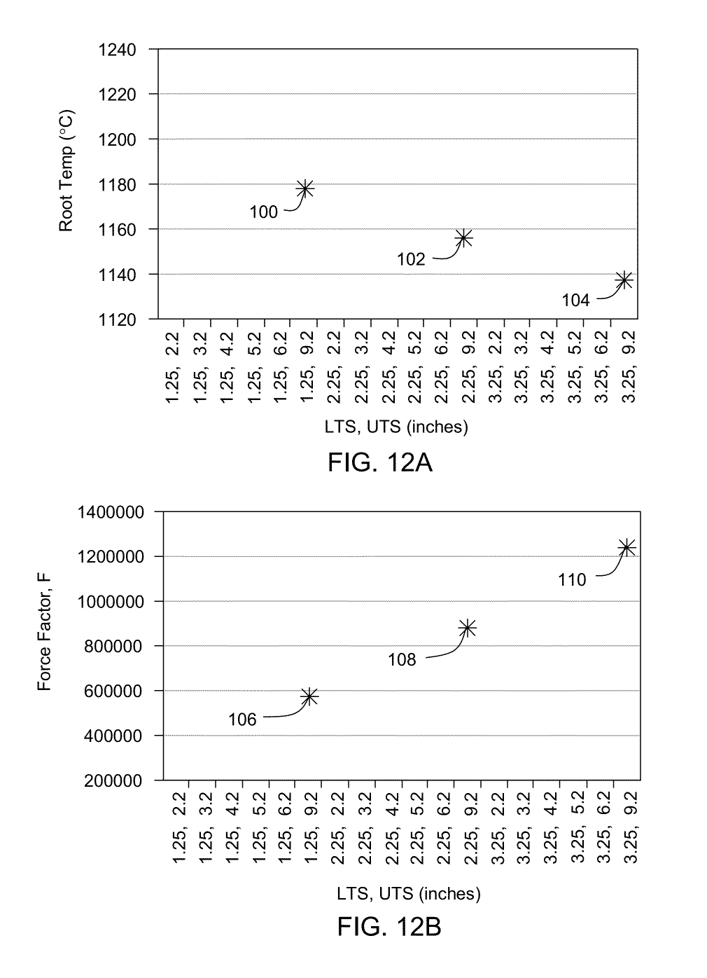

As FIGS. 12A and 12B show, F_{f} can vary significantly with seemingly modest changes in temperature due to the strong dependence of viscosity (μ) on temperature. FIG. 12A shows a plot of calculated root temperature as a function of position for lower thermal shield 54 (LTS) and upper thermal shield 55 (UTS), where stars 100, 102 and 104 are provided for an LTS of 1.25 inches (3.18 cm), 2.25 inches (5.72 cm) and 3.25 inches (8.26 cm) from the adjacent surface of the flow of molten glass, respectively. In all three cases the UTS is 9.2 inches (23.368 cm), which represents a condition of no upper thermal shield 55. That is, the data show the effect of the lower thermal shields without influence from the upper thermal shields. FIG. 12A shows that as the lower thermal shields 54 are withdrawn from the vicinity of the viscous glass ribbon, the root temperature decreases. This occurs, at least in part, because the “view” of the root to lower temperatures below the lower thermal shields increases, thereby cooling the root. FIG. 12B shows the calculated force factor F_{f} under the same conditions as for FIG. 12A, and indicates (through data points, i.e. stars, 106, 108 and 110) that as the position of the lower thermal shield varies, so too does F_{f}. Indeed, the data show that an approximately 40° C. change in root temperature results in an approximately 2× change in force factor. As force factor F_{f} is responsible at least in part on the glass ribbon thickness, it can be concluded that as the horizontal position of the lower thermal shield varies (distance from the glass flow), the thickness of the glass ribbon varies.

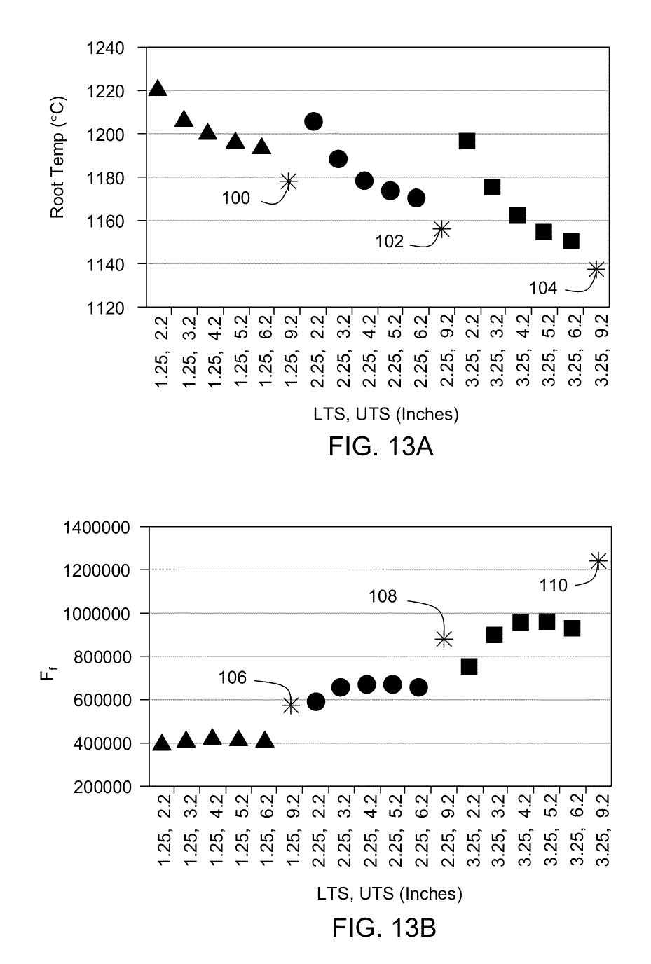

In contrast to the data depicted in FIGS. 12A-12B, FIGS. 13A and 13B illustrate the influence of adding upper thermal shields 55. FIG. 13A shows calculated root temperature as a function of the positions of the lower (LTS) and upper (UTS) thermal shields 54 and 55. As before, data points (stars) 100, 102 and 104 represent the conditions under which the upper thermal shields are fully retracted away from the glass flow and therefore have negligible influence. Accordingly, FIG. 13A shows the influence of multiple positions of upper thermal shields 55 under three horizontal positions of lower thermal shields 54. Again, by horizontal position what is meant is the distance from a forward edge of the thermal shield to the glass flow.

Under the first condition, lower thermal shields 54 are positioned at a distance of 1.25 inches (3.18 cm) from the adjacent surface of the flow of molten glass. The triangles indicate the root temperature as a function of the positions of the upper thermal shields 55 as they step through positions from left to right of 2.2 inches (5.6 cm) from the adjacent surface of the flow of molten glass, 3.2 inches (8.1 cm) from the adjacent surface of the flow of molten glass, 4.2 inches (10.7 cm) from the adjacent surface of the flow of molten glass, 5.2 (13.2 cm), 6.2 inches (15.7 cm) and finally, as indicated by star 100, with the upper thermal shields fully retracted. The data show that as the upper thermal shields are retracted, the root temperature decreases, concluding with the effect had there been no upper thermal shield at all.

The same analysis applies to the second condition (lower thermal shield at 2.25 inches (5.72 cm) from the adjacent surface of the flow of molten glass), represented by the circles and star 102, with the exception that the decrease in root temperature becomes greater when compared to the decrease observed under the first condition.

Under the third condition (lower thermal shield at 3.25 inches (8.26 cm) from the adjacent surface of the flow of molten glass), represented by the squares and star 104, the decrease in root temperature is even greater than under the previous second condition.

FIG. 13B illustrates a similar situation as FIG. 13A, except that rather than root temperature, calculated force factor F_{f} is displayed relative to the positions of the lower and upper thermal shields in respect of the adjacent surface of the flow of molten glass. Similar to FIG. 13A, the triangles, circles and squares represent F_{f} under three positions of lower thermal shields 54, i.e. at 1.25 inches (3.18) cm from the adjacent surface of the flow of molten glass, 2.25 inches (5.72 cm) from the adjacent surface of the flow of molten glass, and 3.25 inches (8.26 cm) from the adjacent surface of the flow of molten glass moving from left to right. Stars 106, 108 and 110 represent F_{f} when the upper thermal shields are fully retracted. The data of FIG. 13B show that under the first condition, where lower thermal shields 54 are at 1.25 inches (3.18) cm from centerline C, the position of upper thermal shields 55 can be significantly varied without significantly affecting F_{f}. Referring back to FIG. 13A and recalling that variations in F_{f} can translate into variations in ribbon thickness, this means that upper thermal shield 55 can be used to vary the root temperature, if needed, without significantly varying F_{f} and therefore ribbon thickness.

As the position of lower thermal shields 54 are retracted, as represented by the circles, and then squares, it can be seen that the variation of F_{f} increases with increasing distance of the lower thermal shields from the adjacent surface of the flow of molten glass. However, the degree of variation is reduced when compared to the overall variation between stars 106, 108 and 110. Moreover, the data further show that for relatively large changes in root temperature, force factor F_{f} remains relatively stable. For example, the triangles of FIG. 13A indicate a temperature variation of approximately 25° C. Yet the force factor representative of the conditions of FIG. 13A remains substantially constant throughout the temperature variation. It is only when the upper thermal shields are fully retracted that the force factor varies significantly as shown by star 106). Thus, the use of thermal shields 54 and 55 below the cooling doors and above the cooling doors, respectively, allows variations in root temperature with a reduced impact on force factor and therefore ribbon thickness.

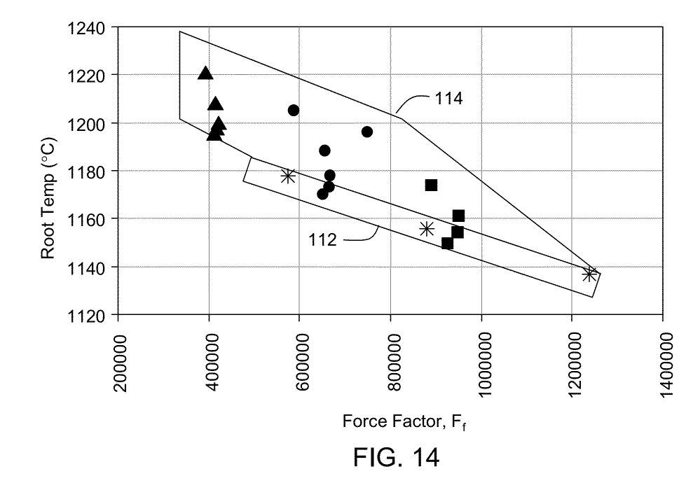

FIG. 14 graphically illustrates the expanded operating space (root temperature and force factor F_{f} as a function of horizontal position x) enabled by the use of both lower and upper thermal shields 54, 55 wherein the stars, circles, triangles and squares correspond to the conditions of FIGS. 13A and 13B. Operating with only lower thermal shields 54 gives an operating space represented by box 112, whereas by employing both lower thermal shields 54 and upper thermal shields 55, that operating space is expanded to include both space 112 and space 114.

The use of both lower and upper thermal shields further permits positioning cooling doors 46 closer to the adjacent surface of the flow of molten glass than would otherwise be possible. Without upper thermal shields 55, the distance between the face 48 of each cooling door 46 and the adjacent surface of the flow of molten glass (e.g. the distance from face 48 and the flow of glass) is limited by the cooling effect on the forming body root from the cooling doors: Each cooling door can be close enough to affect ribbon thickness, but not so close that there is an unacceptable effect on root temperature. By including upper thermal shields 55, which act to raise root temperature, cooling doors 55 can be moved closer to the flow of glass. The effect of moving cooling doors 55 closer to the flow of viscous glass can be dramatic.

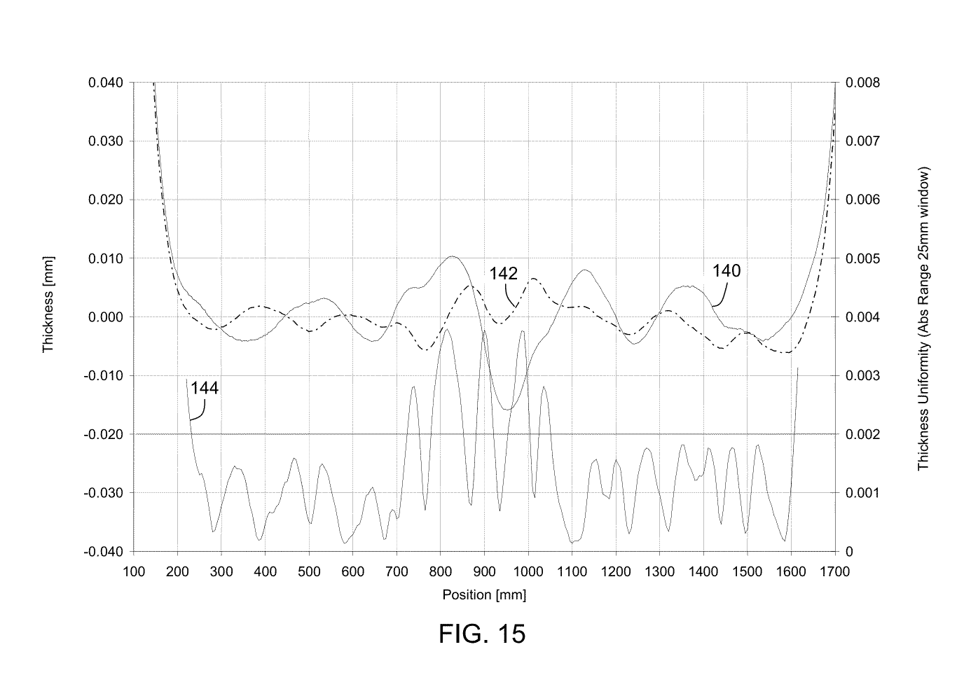

Referring to FIG. 15, curve 140 represents actual measured thickness of a glass ribbon across a width of the ribbon. The mean value of the thickness is subtracted from the thickness data and the result plotted as a deviation. Curve 142 represents the modeled thickness of the glass ribbon after correcting for deviations in thickness wherein the cooling door faces are no closer than approximate 4 inches (10.6 cm) to the surface of the glass ribbon. Curve 144 represents thickness uniformity wherein each point on the curve is the maximum thickness deviation range found in a horizontal range of 25 mm about the point.

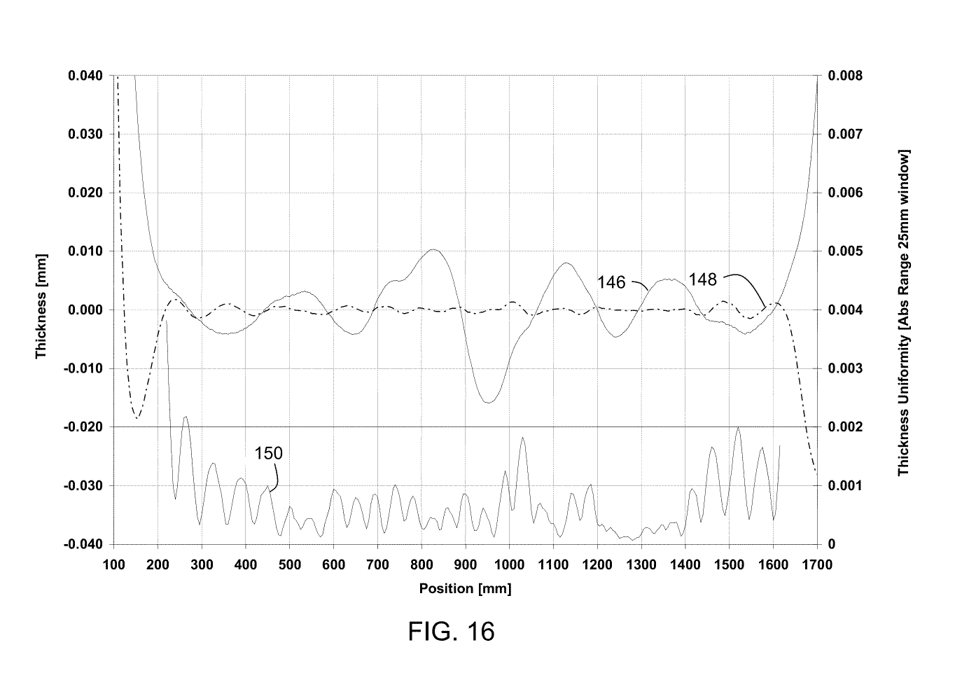

For comparison, FIG. 16 depicts similar data, but illustrates the advantage of being able to move the cooling doors closer to the surface of the glass ribbon. That is, for FIG. 16, the data are modeled for cooling doors positioned approximately 2.5 inches (6.35 cm) from the surfaces of the glass ribbon than the case illustrated in FIG. 15. Accordingly, curve 146 represents actual measured thickness of the glass ribbon across a width of the ribbon. The mean value of the thickness is subtracted from the thickness data and the result plotted as a deviation. Curve 148 represents the modeled thickness of the glass ribbon after correcting for deviations in thickness, and curve 150 represents thickness uniformity of the ribbon wherein each point on the curve is the maximum thickness deviation range found in a horizontal range of 25 mm about the point. As can be readily seen comparing curve 144 with curve 150, the effect of positioning the cooling door faces even 1.5 inches (3.8 cm) closer to the flow of molten glass, as allowed through the use of both upper and lower thermal shields, can significantly decrease thickness deviation (increase thickness uniformity).

In another aspect, the introduction of a second pair of thermal shields (thermal shields 55) provides protection for faces 48 of the cooling doors. As illustrated in FIG. 3, the faces 48 of cooling doors 46 are typically angled relative to a horizontal plane 152. As such, the faces are susceptible to debris (e.g. falling glass, etc.) that may accumulate on the faces and interfere with the cooling effect of the cooling doors. The inclusion of upper thermal shields 55 both protects the faces from debris (by providing an awning effect), but allows increasing an angle of the faces with the horizontal. For example, each face 48 can be positioned vertically, thereby allowing more surface area of a cooling door face to be closer to the surface of the glass ribbon.

### Example

A common problem in fusion forming of glass sheet is the desire to avoid all types of crystallization (devitrification) buildup on the forming surfaces of the forming body. Devitrification can accumulate when the glass temperature falls significantly below its liquidus temperature while flowing on the forming surfaces when the residence time of the glass at the surface-glass interface is relatively long. Suppose the forward (leading) edge of each lower thermal shield is positioned 2.25 inches (5.72 cm) from the adjacent surface of the glass ribbon and that the upper thermal shield is not present (positioned 9.2 inches—23.4 cm—away from the glass under the criteria of FIGS. 13A-13B, but that devitrification accumulation on the forming body has built up quickly and is causing manufacturing problems. Further suppose that a 20° C. increase in root temperature will be needed to reduce this build up. When only lower thermal shields 54 are present, several options are available: Raise the root temperature via either a power source, narrow the gap between the horizontally opposing lower thermal shields, or a combination of both. Simply raising the root temperature to above the liquidus temperature of the molten glass is not a useful option if the temperature increase results in too large a change in force factor. If the force factor is too low, the ribbon weight between the root and the pulling rolls may contribute more force than needed to accomplish the desired drawing of the glass. This condition is called “baggy warp”, so called because the ribbon becomes baggy or sail-like, which produces warping of the glass ribbon.

Accordingly, raising the root temperature 20° C. will produce an approximately 40% reduction in F_{f} and thus would not be practical if a baggy warp condition were to result. However, utilizing both lower thermal shields and upper thermal shields an approximately 20° C. increase in root temperature could be realized with an LTS position of about 3.25 inches (8.26 cm) from the adjacent glass ribbon surface and a UTS position of approximately 3.0 inch (7.62 cm) from the adjacent glass ribbon surface, which keeps F_{f} virtually unchanged. Note here too that the possibility of having the lower thermal shields in a range from about 1.25 inches (3.18 cm) to about 2.25 inches (5.72 cm) from the surface of the flowing glass ribbon has been avoided and now the lower thermal shields are approximately 3.25 inches (8.26 cm) away from the flowing glass and the upper thermal shields are approximately 3.0 inches (7.62 cm) away. The minimum gap distance between horizontally opposing thermal shields, if too small, can greatly increase the probability of the flowing glass adhering to one side of the thermal shield(s) and causing the drawing apparatus to fill up with hot glass—a catastrophic event.

It should be emphasized that the above-described embodiments of the present invention, particularly any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. An apparatus for forming a glass sheet comprising:
an enclosure disposed about a forming body, the enclosure comprising an opening below the forming body to allow a flow of molten glass descending from the forming body to pass from the enclosure;
cooling doors positioned below the forming body;
a first pair of thermal shields positioned below the cooling doors for minimizing radiative heat loss from the forming body, each thermal shield of the first pair of thermal shields comprising at least one segment and being movable relative to the flow of molten glass, wherein each thermal shield of the first pair of thermal shields comprises end portions and a central portion, each of the end portions and the central portion comprising a forward edge relative to the flow of molten glass, and wherein the forward edges of the end portions of each thermal shield of the first pair of thermal shields do not extend closer to a plane of the flow of molten glass than the forward edges of the central portion of each thermal shield of the first pair of thermal shields; and
a second pair of thermal shields positioned above the cooling doors, each thermal shield of the second pair of thermal shields comprising at least one segment and being movable relative to the flow of molten glass, wherein each thermal shield of the second pair of thermal shields comprises end portions and a central portion, each of the end portions and the central portion comprising a forward edge relative to the flow of molten glass and wherein the forward edges of the end portions of each thermal shield of the second pair of thermal shields do not extend closer to a plane of the flow of molten glass than the forward edge of the central portion of each thermal shield of the second pair of thermal shields.

2. The apparatus according to claim 1, wherein the cooling doors comprise face members arranged in an opposing relationship to the flow of molten glass.

3. The apparatus according to claim 2, wherein the face members are vertical.

4. The apparatus according to claim 2, wherein a portion of the face members closest to an adjacent surface of the flow of molten glass is less than 10 cm from the adjacent surface.

5. An apparatus for forming a glass sheet comprising:
an enclosure disposed about a forming body, the enclosure comprising an opening below the forming body to allow a flow of molten glass descending from the forming body to pass from the enclosure;
cooling doors positioned below the forming body;
a first pair of thermal shields positioned below the cooling doors for minimizing radiative heat loss from the forming body, each thermal shield of the first pair of thermal shields comprising at least one segment and being movable relative to the flow of molten glass, wherein each thermal shield of the first pair of thermal shields comprises end portions and a central portion, each of the end portions and the central portion comprising a forward edge relative to the flow of molten glass, and wherein the forward edges of the end portions of each thermal shield of the first pair of thermal shields do not extend closer to a plane of the flow of molten glass than the forward edges of the central portion of each thermal shield of the first pair of thermal shields;
a second pair of thermal shields positioned above the cooling doors, each thermal shield of the second pair of thermal shields comprising at least one segment and being movable relative to the flow of molten glass, wherein each thermal shield of the second pair of thermal shields comprises end portions and a central portion, each of the end portions and the central portion comprising a forward edge relative to the flow of molten glass and wherein the forward edges of the end portions of each thermal shield of the second pair of thermal shields do not extend closer to a plane of the flow of molten glass than the forward edge of the central portion of each thermal shield of the second pair of thermal shields; and
wherein a first distance between the forward edge of the central portion of a thermal shield of the first pair of thermal shields and an adjacent surface of the flow of molten glass is in a range from about 3 cm to about 9 cm and a second distance between the forward edge of the central portion of a thermal shield of the second pair of thermal shields from the adjacent surface of the flow of molten glass is in a range from about 3 cm to about 23 cm.

6. The apparatus according to claim 5, wherein at least a portion of the forward edges of the end portions are recessed relative to the forward edge of the central portion.

7. The apparatus according to claim 5, wherein the cooling doors comprise face members arranged in an opposing relationship to the flow of molten glass.

8. The apparatus according to claim 7, wherein the face members are vertical.

9. The apparatus according to claim 7, wherein a portion of the face members closest to an adjacent surface of the flow of molten glass is less than 10 cm from the adjacent surface.

10. A method of forming glass by a downdraw method comprising:
flowing molten glass over a forming body, the molten glass descending from the forming body in a continuous ribbon, there being a pair of opposing cooling doors positioned below the forming body, each cooling doors comprising a plurality of gas outlets for directing a cooling gas against face members of the cooling doors;
positioning a first pair of thermal shields disposed below the cooling doors for minimizing radiative heat loss from the forming body, each thermal shield of the first pair of thermal shields comprising at least one segment and being movable relative to the flow of molten glass, wherein each thermal shield of the first pair of thermal shields comprises end portions and a central portion, each of the end portions and the central portion comprising a forward edge relative to the flow of molten glass, and wherein the forward edges of the end portions of each thermal shield of the first pair of thermal shields do not extend closer to a plane of the flow of molten glass than the forward edge of the central portion of the first pair of thermal shields;
positioning a second pair of thermal shields disposed above the cooling doors, each thermal shield of the second pair of thermal shields comprising at least one segment and being movable relative to the flow of molten glass, wherein each thermal shield of the second pair of thermal shields comprises end portions and a central portion, each of the end portions and the central portion comprising a forward edge relative to the flow of molten glass and wherein the forward edges of the end portions of each thermal shield of the second pair of thermal shields do not extend closer to a plane of the flow of molten glass than the forward edge of the central portion of the second pair of thermal shields; and
wherein after the positioning of the first and second pairs of thermal shields, a first distance between the forward edge of the central portion of a thermal shield of the first pair of thermal shields and an adjacent surface of the flow of molten glass is in a range from about 3 cm to about 9 cm and a second distance between the forward edge of the central portion of a thermal shield of the second pair of thermal shields from the adjacent surface of the flow of molten glass is in a range from about 3 cm to about 23 cm.

11. The method according to claim 10, further comprising positioning a portion of the face members closest to an adjacent surface of the flow of molten glass less than 10 cm from the adjacent surface.

12. A method of drawing glass from a glass drawing apparatus comprising:
flowing separate streams of molten glass over converging forming surfaces of a forming body, the separate streams of molten glass joining at a bottom of the forming body to form a ribbon of molten glass;
selecting a predetermined temperature profile along a length of the glass drawing apparatus;
positioning a first thermal shield wherein a forward edge of the thermal shield is in a range from about 3 cm to about 9 cm from a surface of the ribbon of molten glass;
positioning a second thermal shield wherein a forward edge of the thermal shield is in a range from about 3 cm to about 23 cm from the bottom of the forming body; and
positioning a cooling door located between the first and second thermal shields wherein a face of the cooling door at its closest approach to the ribbon of molten glass is less than about 10 cm from an adjacent surface of the ribbon of molten glass.
